(19) United States
(12) Patent Application Publication
(10) Pub. No.: US 2011/0086749 A1
(43) Pub. Date: Apr. 14, 2011

(54) MANUFACTURING MACHINE FOR PLASTIC CONTAINERS

(76) Inventor: Manuel IGLESIAS RODRIGUEZ, Victoria (AR)

(21) Appl. No.: 12/901,352

(22) Filed: Oct. 8, 2010

(30) Foreign Application Priority Data
Oct. 8, 2009 (AR) 20090103887

(51) Int. Cl. B31B 17/00

(52) U.S. Cl. 493/84

(57) ABSTRACT

A manufacturing machine for plastic containers having an upper and a lower portion with respective joining edges, comprising a first fixed base with an axle mounted thereto, a circular platform mounted upon the axle, and a plurality of welding stations mounted over the circular platform. Each welding station comprises a second fixed base that receives the lower portion of the container and a movable head having suction heads that receives the upper portion of the container therein, and it slides up and down upon a column mounted to the circular platform. The present invention further comprises a fusion station that acts upon the joining edges of the upper and lower portion and it comprises a hot plate that is positioned between the joining upper and lower edges and raises the temperature of the material, thus fusing the material. A robot loads new upper and lower portions into the welding station.

### BACKGROUND OF THE INVENTION

1. Field of the Invention

The present invention relates to a manufacturing machine for containers, and more particularly, to a high efficiency manufacturing machine for plastic containers.

2. Other Related Applications

The present application claim priority of pending Argentinean Patent Application No. 20090103887, filed on Oct. 8, 2009, which is hereby incorporated by reference.

3. Description of the Related Art

Specifically, the present application refers to a manufacturing machine for containers, developed for plastic container having a body and a cap with the use of resin injection and thermo configuration of a resin sheet and later weld. The container's opening having a smaller or same diameter than that of the base, such as bottles, baby food bottles, drums, tanks, and other plastic containers with similar characteristics.

Applicant believes that the closest references correspond to Argentinean pending Patent Application No. 040101705, and U.S. now abandoned patent application Ser. No. 11/569,322 filed by the inventor of the present application for a method of producing plastic containers comprising an opening having a smaller diameter than that of the base, and the container thus produced. However, it differs from the present invention because previously filed applications comprise the steps of producing a lower portion and an upper portion of a container separately, using a resin injection process, and welding the lower and upper portions using a hot plate process. The resulting container comprises an opening having a first diameter that is smaller than a second diameter of the base or a longest linear dimension of the base. The lower portion and the upper portion are connected to each other along peripheral edges by means of a weld seam. The lower portion and the upper portion each comprise straight peripheral socketing edges comprising two surfaces which form a right angle and which define an edge at the intersection thereof.

One disadvantage of the method of previously filed application is that their second step (welding), is the delay in time to obtain a correct welding seam of the lower and upper portions, making the process inefficient. Such delay cannot be reduced without attempting against the quality of the final product.

Other patents describing the closest subject matter provide for a number of more or less complicated features that fail to solve the problem in an efficient and economical way. None of these patents suggest the novel features of the present invention.

### SUMMARY OF THE INVENTION

The present manufacturing machine for plastic containers overcome the above-mentioned disadvantage.

It is therefore one of the main objects of the present invention to provide a manufacturing machine for plastic containers that produces plastic containers with an excellent welding seam, which satisfactorily pass the impact tests.

It is another object of this invention to provide a manufacturing machine for plastic containers that has a high production capability.

It is another object of this invention to provide a manufacturing machine for plastic containers that produce a container with excellent technical characteristics of the welding seam.

It is another object of this invention to provide a manufacturing machine for plastic containers comprising an opening having a smaller diameter than that of the base.

It is yet another object of this invention to provide such a device that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents a cross sectional view of the manufacturing machine for plastic containers, object of the present application.

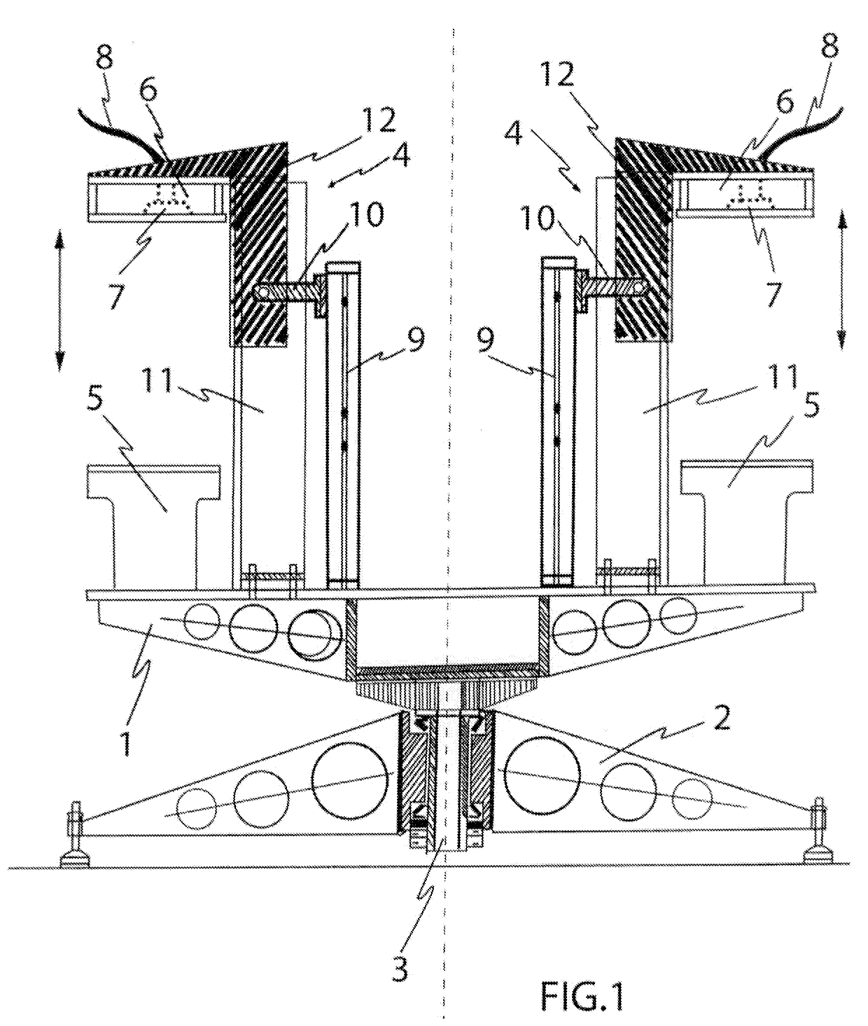

FIG. 2 is a top plan view of the preferred embodiment for instant invention.

FIG. 3 is an isometric view of one of the welding stations of the instant invention.

FIG. 4 is an isometric view showing the movable head assembly of one of the welding stations.

FIG. 5 is a top plan view of an alternate embodiment for the instant invention.

### DETAILED DESCRIPTION OF THE PREFERRED EMBODIMENT

The instant invention has a high-production capability and produces a container with excellent technical characteristics of the welding seam.

Referring now to the drawings, the present invention is generally referred to with numeral 100. It can be observed that it basically includes revolving circular platform 1 disposed over fixed base 2. Platform 1 is mounted to rotating axle 3 mounted to fixed base 2. Platform 1 is rotationally moved by a motor (not shown). The rotational movement of platform 1 is adjusted according to the steps described below.

A plurality of welding stations 4 is fixedly mounted over revolving circular platform 1. The welding of the lower and upper portions of a container is made in welding stations 4. Each welding station 4 comprises fixed base 5, in which a lower portion of a container is cooperatively disposed, and a movable head 6. Movable head 6 has suction heads 7, which hold the upper portion of the container by a vacuum pressure generated by a vacuum pump (not shown) and transmitted through tubing 8.

Each movable head 6 is mounted to pneumatic cylinder 9 with supporting member 10. Pneumatic cylinder 9 is also fixedly mounted to revolving circular platform 1. The movements, positions, stopping times and pressure exerted by each supporting member 10 of pneumatic cylinder 9 are controlled by a programmable logic controller (PLC) (not shown). Movable head 6 slides up and down upon column 11, which is in turn fixedly mounted to revolving circular platform 1, with lineal displacement guides (not shown) mounted to lateral walls 12.

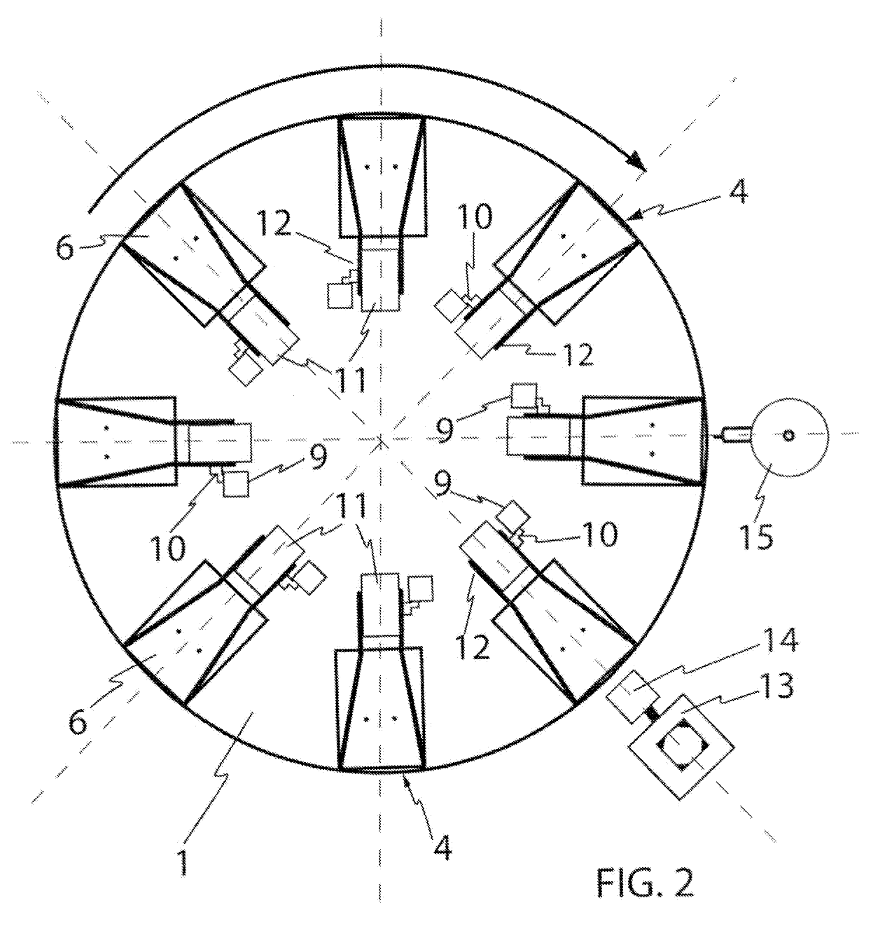

As seen in FIG. 2, welding stations 4 are fixedly mounted over revolving circular platform 1. Fusion station 13 brings into the fusion state the material of the joining edges of the upper and lower portion of the container intended to join. Hot plate 14 is positioned between the upper and lower joining edges of the container and raises the temperature of the material until 100 and 350° C., thus fusing the material by contact and under pressure during a predetermined period of time. Such period of time is predetermined according to the material used for the container manufacturing process.

Platform 1 and welding stations 4 are within a housing that keep a temperature range between 5 and 80° C. In that way the upper and lower portion of the container are preheated.

Robot 15 removes the final containers from each welding station 4 that stop in front and position, and loads welding station 4 with new upper and lower portions according to the programmed automatic cycle.

In an alternate embodiment, manufacturing machine for plastic containers 100 may include a piston mounted to each welding station that push out the final container from welding station 4, when it is at a position before or at the position of robot 15, in such a way that robot 15 only position new upper and lower portions in each welding station 4 that reaches its position.

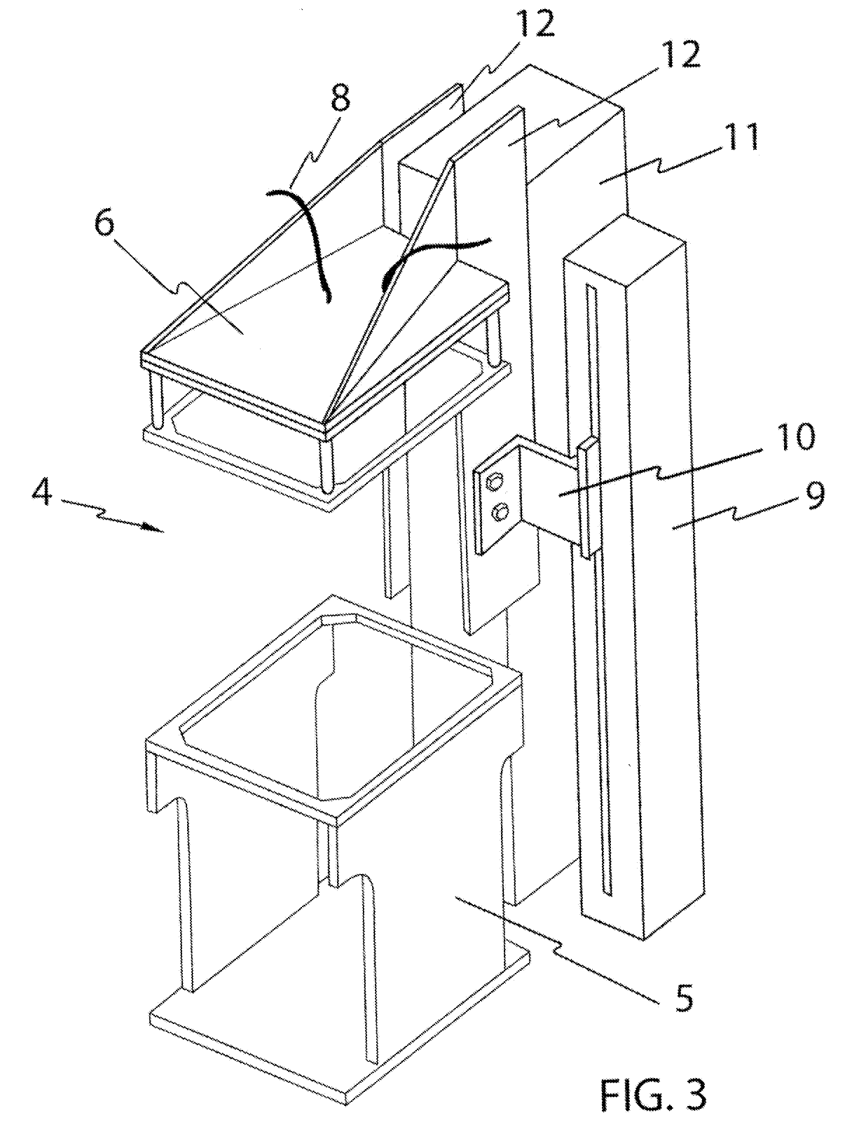

Seen in FIG. 3, is fixed base 5, in which is of a cooperative shape and dimension to receive the lower portion of the container. Movable head 6 is mounted to pneumatic cylinder 9 with supporting member 10. As mentioned before, movable head 6 slides up and down upon column 11 with lineal displacement guides (not shown) mounted to lateral walls 12.

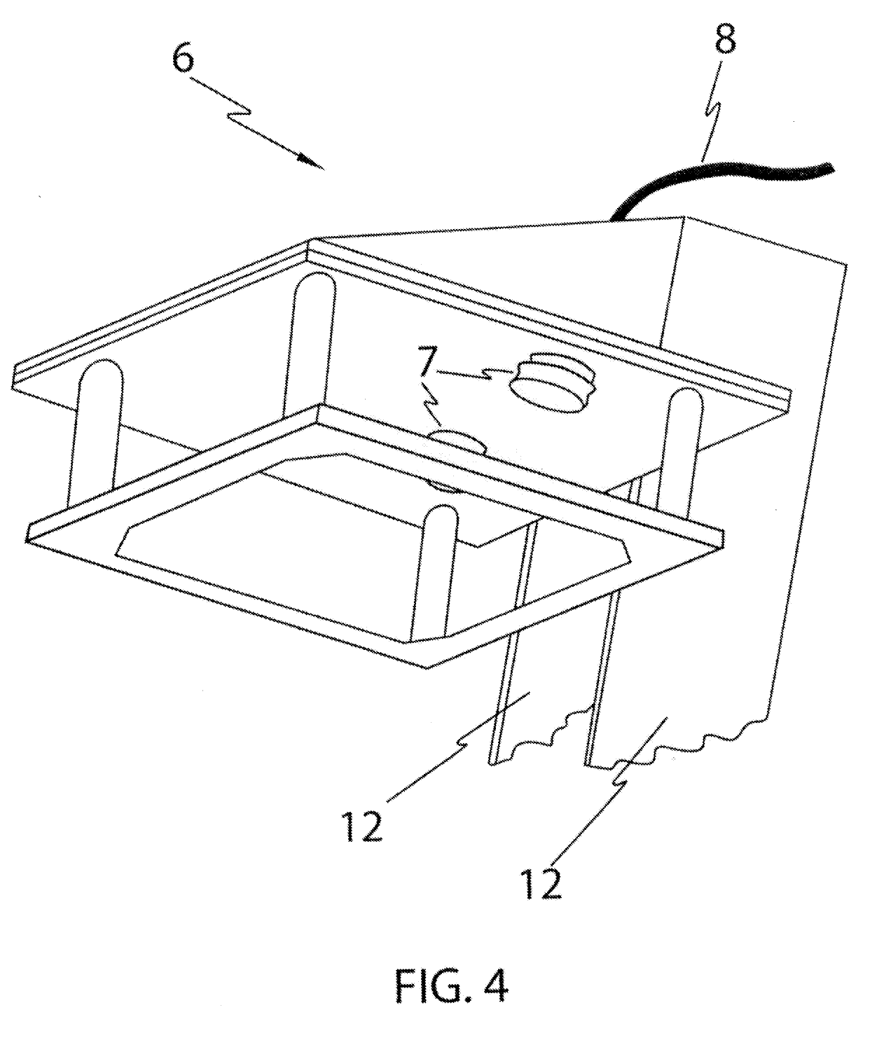

Seen in FIG. 4, are suction heads 7, of movable head 6, connected to respective vacuum tubing 8, which suction effect holds the upper portion of the container.

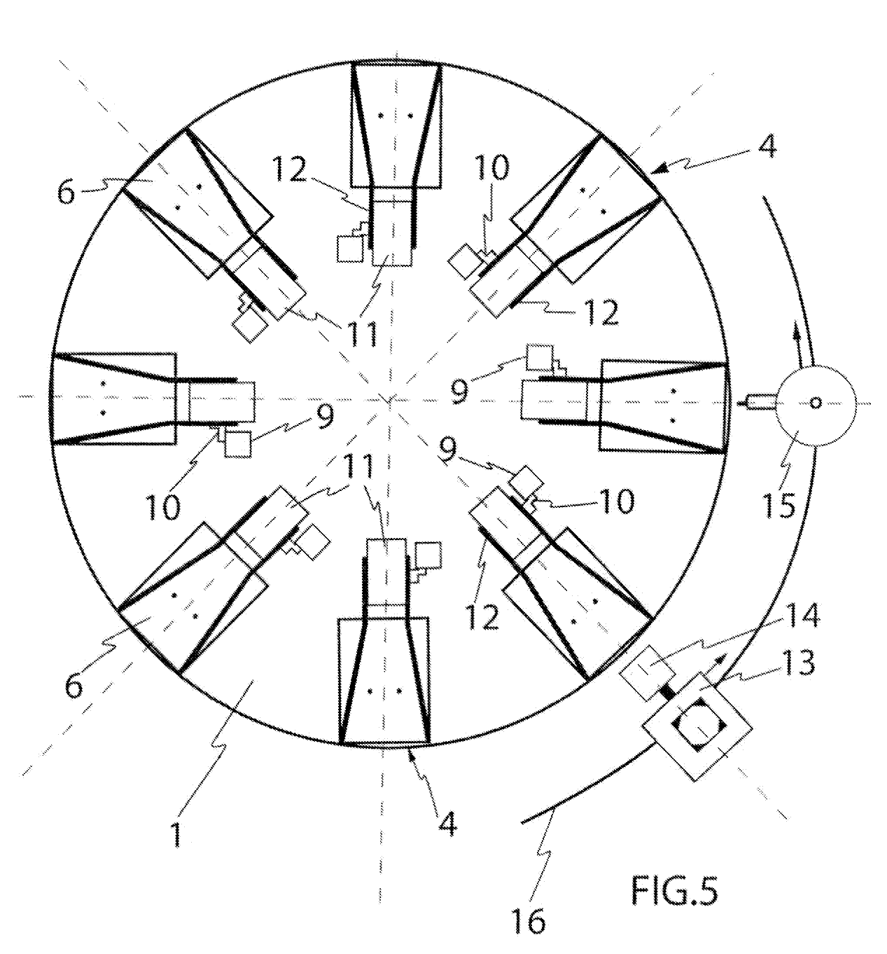

FIG. 5 shows the top view of an alternate embodiment for manufacturing machine for plastic containers 100. In this alternate embodiment, circular platform 1 is fixed while fusion station 13 and robot 15 moves along rail 16 (partially shown) that extends around platform 1. Robot 15 removes the final containers from each welding station 4 and position new upper and lower portions according to the programmed automatic cycle. Following robot 15, fusion station 13 moves onto the corresponding welding station 4 to start the heating of the joining edges of the upper and lower portions up to the fusion point of the material.

Manufacturing machine for plastic containers 100 perform its operations according to the following steps:
A. Robot 15, in front of a predetermined welding station 4, positions a new lower portion of a container into fixed base 5 and a upper portion in movable head 6, which suction heads 7 hold the upper portion in place.
B. Circular platform 1 rotates until it positions loaded welding station 4 in front of fusion station 13.
C. Hot plate 14 is positioned between joining edges of the upper and lower portion of the container loaded in welding station 4, and movable head 6 is moved downwardly until the joining edges of the upper and lower portions contact hot plate 14. Once in contact, the temperature of hot plate 14 raises up to the fusion point of the material. The fusion process is made with any, but not limited to, of the following methods: ultrasound, high frequency, laser, hot air or spin welding. This step is completed in a time period 1 and 50 seconds
D. Movable head 6 moves upwardly and hot plate 14 retracts, moving away from the welding station 4. Then, movable head 6 moves downwardly until the joining edges of the upper and lower portions contact each other starting their welding process. The welding process is made under a variable, which comprises a first stage at a pressure between 0.100 Kg/cm² and 20 Kg/cm², and a second stage at a pressure between 1 Kg/cm² and 50 Kg/cm². The second stage is completed in a time period 1 and 250 seconds.
E. Circular platform 1 rotates until the next welding station 4, previously loaded by robot 15, is positioned in front of fusion station 13.
F. Repetition of the steps C and D for the new welding station 4.
G. Circular platform 1 rotates until the next welding station 4, previously loaded by robot 15, is positioned in front of fusion station 13. Repetition of the previous steps.

During the continuous operation of manufacturing machine for plastic containers 100 and previous to the execution of the above-mentioned step A, robot 15 removes the final containers from each welding station 4 that stop in front and position. As mentioned before, in an alternate embodiment a piston pushes out the final containers from the welding station 4 when it is at a position before or at the position of robot 15.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A manufacturing machine for plastic containers having an upper and a lower portion with respective joining edges, comprising:
A) a first fixed base;
B) an axle mounted to said first fixed base;
C) a circular platform mounted upon said axle;
D) a plurality of welding stations fixedly mounted over said circular platform, each welding station comprises a second fixed base and a movable head, said second fixed base cooperatively receive said lower portion of said container, said movable head cooperatively receives said upper portion, said movable head having at least one suction head to hold said upper portion of said container in place by vacuum pressure generated by an external vacuum pump and transmitted through tubing members, said movable head is mounted to a pneumatic cylinder with a supporting member and slides up and down upon a column, said column and said pneumatic cylinder are fixedly mounted to said circular platform.
E) a fusion station that brings into the fusion state the material of said joining edges of said upper and lower portion of said container, said fusion station comprises a hot plate, said hot plate is positioned between said joining upper and lower edges of said container and raises the temperature of the material, thus fusing said material by contact during a predetermined period of time; and
F) a robot that loads new said upper and lower portions into said welding station when each of said welding station stops at a position in front of said robot.

2. The manufacturing machine for plastic containers set forth in claim 1, further characterized in that said platform rotates upon said first fixed base.

3. The manufacturing machine for plastic containers set forth in claim 2, further characterized in that said platform and said welding stations are within a housing that keep a predetermined temperature range in which said upper and lower portion of said container are preheated before reach the position of the fusion station.

4. The manufacturing machine for plastic containers set forth in claim 3, further characterized in that said predetermined temperature range in which said upper and lower portion of said container are preheated is 5 and 80° C.

5. The manufacturing machine for plastic containers set forth in claim 2, further characterized in that said robot removes the final containers from each of said welding station when each of said welding station stops at a position in front of said robot and before said robot loads new said upper and lower portions into said welding station.

6. The manufacturing machine for plastic containers set forth in claim 1, further characterized in that a piston is mounted to each said welding station, said piston pushes out the final containers from each of said welding station when each of said welding station stops at a position in front of said robot and before said robot loads new said upper and lower portions into said welding station.

7. The manufacturing machine for plastic containers set forth in claim 1, further characterized in that a piston is mounted to each said welding station, said piston push out the final containers from each of said welding station when each of said welding station stops at a position before the position of said robot.

8. The manufacturing machine for plastic containers set forth in claim 1, further characterized in that the movements, positions, stopping times and pressure exerted by each said supporting member of said pneumatic cylinder are controlled by a programmable logic controller (PLC).

8. The manufacturing machine for plastic containers set forth in claim 2, further characterized in that said platform is rotationally moved by a motor.

9. The manufacturing machine for plastic containers set forth in claim 1, further characterized in that said second fixed base has cooperative shape and dimension to receive said lower portion of said container.

10. The manufacturing machine for plastic containers set forth in claim 1, further characterized in that said platform is fixed and said fusion station and said robot moves along a rail that extends around said platform, said robot removes the final containers from each of said welding stations and positions new upper and lower portions, said fusion station moves onto the next said welding station to start the heating of said joining edges of said upper and lower portions up to the fusion point of the material.

11. The manufacturing machine for plastic containers set forth in claim 1, further characterized in that its operation are regulated in following steps:
A. Said robot, in front of a predetermined said welding station, positions a new said lower portion of said container into said second fixed base and a new said upper portion in said movable head, which said suction heads hold said upper portion in place.
B. Said circular platform rotates until the position of loaded said welding station is in front of said fusion station.
C. Said hot plate is positioned between said joining edges of said upper and lower portion of said container loaded in said welding station, and said movable head is moved downwardly until said joining edges of said upper and lower portions contact said hot plate, once in contact, the temperature of said hot plate raises up to the fusion point of the material.
D. Said movable head moves upwardly and said hot plate retracts, moving away from said welding station, said movable head moves downwardly until the joining edges of said upper and lower portions contact each other starting their welding process.
E. Said circular platform rotates until the next said welding station, previously loaded by said robot, is positioned in front of said fusion station.
F. Repetition of steps C and D for the new said welding station.
G. Said circular platform rotates until the next said welding station, previously loaded by said robot, is positioned in front of said fusion station, and repetition of the previous steps.

12. The manufacturing machine for plastic containers set forth in claim 11, further characterized in that said step C is completed in a time period 1 and 50 seconds.

13. The manufacturing machine for plastic containers set forth in claim 11, further characterized in that, in said step D, said welding process is made in a first stage at a pressure between 0.100 Kg/cm² and 20 Kg/cm², and a second stage at a pressure between 1 Kg/cm² and 50 Kg/cm².

14. The manufacturing machine for plastic containers set forth in claim 13, further characterized in that, in said step C, said second stage is completed in a time period 1 and 250 seconds.

15. The manufacturing machine for plastic containers set forth in claim 11, further characterized in that said fusion is made with any, but not limited to, the following methods ultrasound, high frequency, laser, hot air or spin welding.
